(19) United States
(12) Patent Application Publication
(10) Pub. No.: US 2009/0185123 A1
(43) Pub. Date: Jul. 23, 2009

(54) Liquid crystal display device

(75) Inventors: Masateru Morimoto, Mobara (JP); Shinichi Komura, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/289,728

(22) Filed: Nov. 3, 2008

(30) Foreign Application Priority Data
Jan. 21, 2008 (JP) 2008-010380

(51) Int. Cl. G02F 1/1343

(52) U.S. Cl. 349/139

(57) ABSTRACT

In an IPS type liquid crystal display device, it is attempted to improve display quality. In the IPS type liquid crystal display device, in the case where a liquid crystal layer is of a positive liquid crystal, a counter electrode is divided for each display line. When two adjacent display lines are defined as one display line and the other display line, respectively, a gap between the counter electrode of the one display line and the counter electrode of the other display line extends in a direction of the display line as a whole while bending locally. The gap has a first portion extending along an extending direction of a video line and a second portion extending from the first portion along a direction crossing the video line. An initial alignment axis of the liquid crystal layer is in a direction within a range of +5° to +20° or −5° to −20° clockwise with respect to the video line. When an angle measured clockwise from the initial alignment axis of the liquid crystal layer to the second portion of the gap is θ1, a relation of 88°≦θ1≦92° is satisfied. The video line is formed of a light-shielding material, and the first portion of the gap is planary overlapped with the video line.

The present application claims priority from Japanese application JP2008-10380 filed on Jan. 21, 2008, the content of which is hereby incorporated by reference into this application.

### BACKGROUND OF THE INVENTION

1. Field of the Invention

The present invention relates to a liquid crystal display device and more particularly to a technique effectively applied to an In Plane Switching (IPS) type liquid crystal display device.

2. Description of Related Art

As a liquid crystal display device, an IPS type liquid crystal display device has been known. In the IPS type liquid crystal display device, a pixel electrode (PX) and a counter electrode (CT) are formed above the same substrate, and an electric field is applied therebetween to rotate liquid crystals in the substrate plane thereby controlling contrast. Therefore, the IPS type liquid crystal display device has a feature that the contrast or the tone of a display image when a screen is viewed from the oblique direction is not inverted.

Related art documents associated with the invention are as follows:

Patent Document 1: JP-A-2002-221726

Patent Document 2: Japanese Patent Application 2006-193485

### SUMMARY OF THE INVENTION

FIG. 10 and FIG. 11 are views relating to a conventional IPS type liquid crystal display device, in which FIG. 10 is a plan view showing an electrode structure of one subpixel, and FIG. 11 is a schematic view for explaining a state where liquid crystal molecules move due to an electric filed between two adjacent counter electrodes.

In the conventional IPS type liquid crystal display device, a counter electrode (CT) is divided for each display line and driven by one line inversion driving in order to reduce power consumption as shown in FIG. 10. Further, when two adjacent display lines are defined as one display line and the other display line, respectively, a gap (break) 10 between the counter electrode (CT) of the one display line and the counter electrode (CT) of the other display line extends in a straight line fashion along a direction (extending direction of scanning line (GL)) of the display line. A liquid crystal initial alignment axis (S) of a liquid crystal layer is in a direction within a range of +70° to +80° or −70° to −80° clockwise with respect to the gap 10 (scanning line (GL)) in the case of a positive liquid crystal. Here, DL denotes a video line, a-Si denotes a semiconductor layer, SLT denote slits formed in the pixel electrode (PX), CH denotes a contact hole, and CHK denotes an opening portion formed in the counter electrode (CT).

With the one line inversion driving, however, a reference voltage (counter voltage or common voltage) applied to the counter electrode (CT) of the one display line and a reference voltage (counter voltage or common voltage) applied to the counter electrode (CT) of the other display line are reversed in polarity from each other in the two adjacent display lines. Therefore, an electric field (F1) is generated between the counter electrode (CT) of the one display line and the counter electrode (CT) of the other display line even at the time of black display as shown in FIG. 11. Thus, liquid crystal molecules (LC1) in the liquid crystal layer move in a direction different from the liquid crystal initial alignment axis (S) to form a light leakage point (black floating point). As a result, the display quality could conceivably be degraded. The above-described light leakage point can be suppressed by disposing a light-shielding film (black matrix) so as to planary overlap with the gap 10. However, such a method decreases an aperture ratio.

The invention has been made to overcome the above problem in the related art, and an object thereof is to provide a technique that can improve display quality in the IPS type liquid crystal display device.

The above and other objects and novel features of the invention will be understood from the description of the specification and the accompanying drawings.

A typical outline of the invention disclosed herein will be briefly described below.

(1) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels, the liquid crystal layer is of a positive liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a range of +5° to +20° or −5° to −20° clockwise with respect to the video line, when an angle measured clockwise from the initial alignment axis of the liquid crystal layer to the second portion of the gap is θ1, a relation of 88°≦θ1≦92° is satisfied, the video line is formed of a light-shielding material, and the first portion of the gap is planary overlapped with the video line.

(2) In (1), the pixel electrode is formed in an upper layer than the counter electrode on the first substrate side.

(3) In (1), the counter electrode is formed in an upper layer than the pixel electrode on the first substrate side.

(4) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels, the liquid crystal layer is of a positive liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a range of +5° to +20° or −5° to −20° clockwise with respect to the video line, when an angle measured clockwise from the initial alignment axis of the liquid crystal layer to the second portion of the gap is θ1, a relation of 88°≦θ1≦92° is satisfied, and the first portion of the gap is planary overlapped with a light-shielding metal electrode, the light-shielding metal electrode is formed in a lower layer than the counter electrode and electrically connected with the pixel electrode.

(5) In (4), the pixel electrode is formed in an upper layer than the counter electrode on the first substrate side.

(6) In (4), the counter electrode is formed in an upper layer than the pixel electrode on the first substrate side.

(7) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels, the liquid crystal layer is of a positive liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a range of +5° to +20° or −5° to −20° clockwise with respect to the video line, when an angle measured clockwise from the initial alignment axis of the liquid crystal layer to the second portion of the gap is θ1, a relation of 88°≦θ1≦92° is satisfied, the second substrate has a light-shielding film in an area opposing to the first portion of the gap, and the first portion of the gap is planary overlapped with the light-shielding film.

(8) In (7), the pixel electrode is formed in an upper layer than the counter electrode on the first substrate side.

(9) In (7), the counter electrode is formed in an upper layer than the pixel electrode on the first substrate side.

(10) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels and a plurality of scanning lines extending along a direction crossing the video lines, the liquid crystal layer is of a negative liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a ranger of +5° to +20° or −5° to −20° clockwise with respect to the scanning line, when an angle measured clockwise from a direction perpendicular to the initial alignment axis of the liquid crystal layer to the second portion of the gap is Θ1, a relation of 88°≦Θ1≦92° is satisfied, the video line is formed of a light-shielding material, and the first portion of the gap is planary overlapped with the video line.

(11) In (10), the pixel electrode is formed in an upper layer than the counter electrode on the first substrate side.

(12) In (10), the counter electrode is formed in an upper layer than the pixel electrode on the first substrate side.

(13) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels and a plurality of scanning lines extending along a direction crossing the video lines, the liquid crystal layer is of a negative liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a range of +5° to +20° or −5+ to −20° clockwise with respect to the scanning line, when an angle measured clockwise from a direction perpendicular to the initial alignment axis of the liquid crystal layer to the second portion of the gap is θ1, a relation of 88°≦Θ1≦92° is satisfied, and the first portion of the gap is planary overlapped with a light-shielding metal electrode, the light-shielding metal electrode is formed in a lower layer than the counter electrode and electrically connected with the pixel electrode.

(14) In (13), the pixel electrode is formed in an upper layer than the counter electrode on the first substrate side.

(15) In (13), the counter electrode is formed in an upper layer than the pixel electrode on the first substrate side.

(16) A liquid crystal display device includes a liquid crystal display panel having a first substrate, a second substrate, and a liquid crystal layer interposed between the first substrate and the second substrate, the liquid crystal display panel having a plurality of subpixels, each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and the counter electrode and the pixel electrode causing an electric field to be generated due to a potential difference therebetween thereby driving liquid crystal in the liquid crystal layer.

The first substrate has a plurality of video lines for inputting a video signal to each of the subpixels and a plurality of scanning lines extending along a direction crossing the video lines, the liquid crystal layer is of a negative liquid crystal, the counter electrode is divided for each display line, when two adjacent display lines are defined as one display line and the other display line, respectively, a gap between the counter electrode of the one display line and the counter electrode of the other display line extends in a direction of the display line as a whole while bending locally, the gap has a first portion extending along an extending direction of the video line and a second portion extending from the first portion along a direction crossing the video line, an initial alignment axis of the liquid crystal layer is in a direction within a range of +5° to +20° or −5° to −20° clockwise with respect to the scanning line, when an angle measured clockwise from a direction perpendicular to the initial alignment axis of the liquid crystal layer to the second portion of the gap is Θ1, a relation of 88°≦Θ1≦92° is satisfied, and the second substrate has a light-shielding film in an area opposing to the first portion of the gap, and the first portion of the gap is planary overlapped with the light-shielding film.

(17) In (16), the pixel electrode is formed in an upper layer than the counter electrode on the first substrate side.

(18) In (16), the counter electrode is formed in an upper layer than the pixel electrode on the first substrate side.

A typical advantage obtained by the invention disclosed herein will be briefly described below.

According to the liquid crystal display device of the invention, display quality can be improved.

### BRIEF DESCRIPTION OF THE DRAWINGS

FIG. 1 is a plan view showing a state where a counter electrode is divided for each display line in an IPS type liquid crystal display device as a first embodiment of the invention;

FIG. 2 is a plan view showing an electrode structure of each subpixel as viewed through the counter electrode of FIG. 1;

FIG. 3 is a plan view enlarging a part of FIG. 2, showing a relation between a liquid crystal initial alignment axis and an extending direction of a gap between the counter electrodes when a positive liquid crystal is used;

FIG. 4 is a schematic view for explaining a state where liquid crystal molecules move due to an electric field between two adjacent counter electrodes in the IPS type liquid crystal display device as the first embodiment of the invention;

FIG. 5 is a cross sectional view showing a cross sectional structure taken along the line A-A′ of FIG. 3;

FIG. 6 is a plan view enlarging a part of FIG. 2, showing a relation between a liquid crystal initial alignment axis and an extending direction of a gap between the counter electrodes when a negative liquid crystal is used;

FIG. 7 is a plan view showing an electrode structure of one subpixel in an IPS type liquid crystal display device as a second embodiment of the invention;

FIG. 8 is a plan view showing an electrode structure of one subpixel in an IPS type liquid crystal display device as a third embodiment of the invention;

FIG. 9 is a plan view showing an electrode structure of one subpixel in an IPS type liquid crystal display device as a fourth embodiment of the invention;

FIG. 10 is a plan view showing an electrode structure of one subpixel in a conventional IPS type liquid crystal display device; and

FIG. 11 is a schematic view for explaining a state where liquid crystal molecules move due to an electric field between two adjacent counter electrodes in the conventional IPS type liquid crystal display device.

### DESCRIPTION OF THE PREFERRED EMBODIMENTS

Hereinafter, embodiments of the invention will be described in detail with reference to the drawings. Throughout the drawings for describing the embodiments of the invention, those having the same function are designated by the same reference numeral, and a repetitive description thereof will be omitted.

### First Embodiment

In a first embodiment, an example in which the invention is applied to a fully transmissive liquid crystal display device will be described as an IPS type liquid crystal display device.

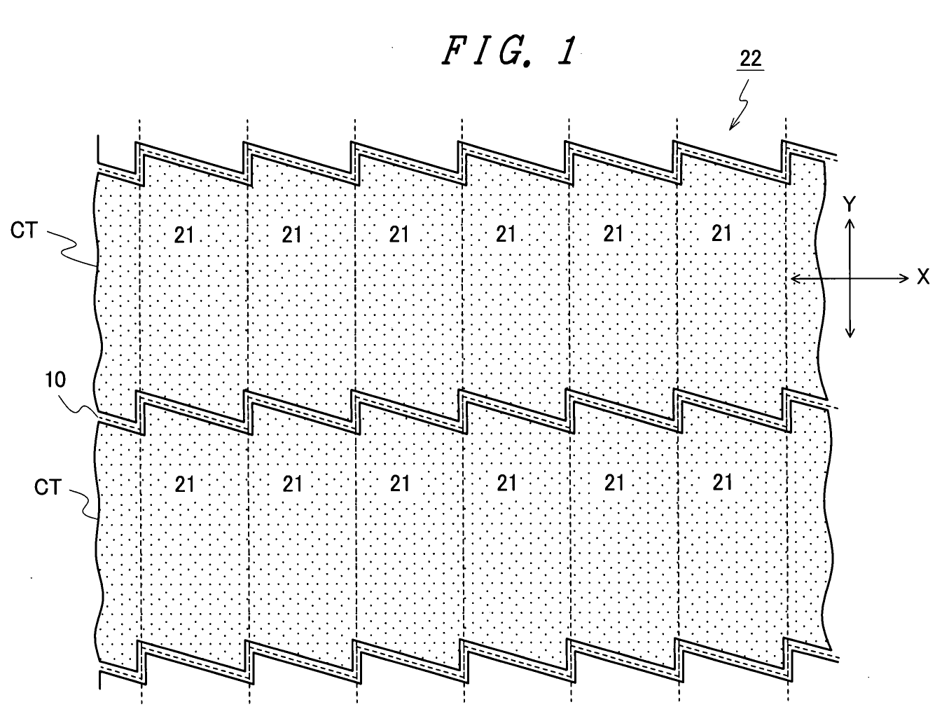

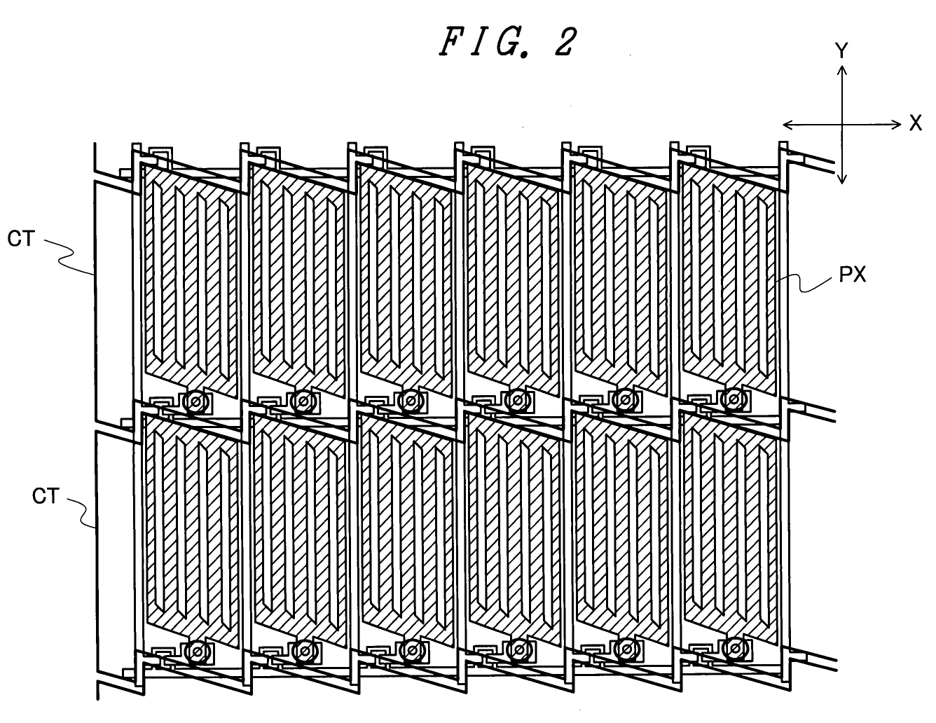

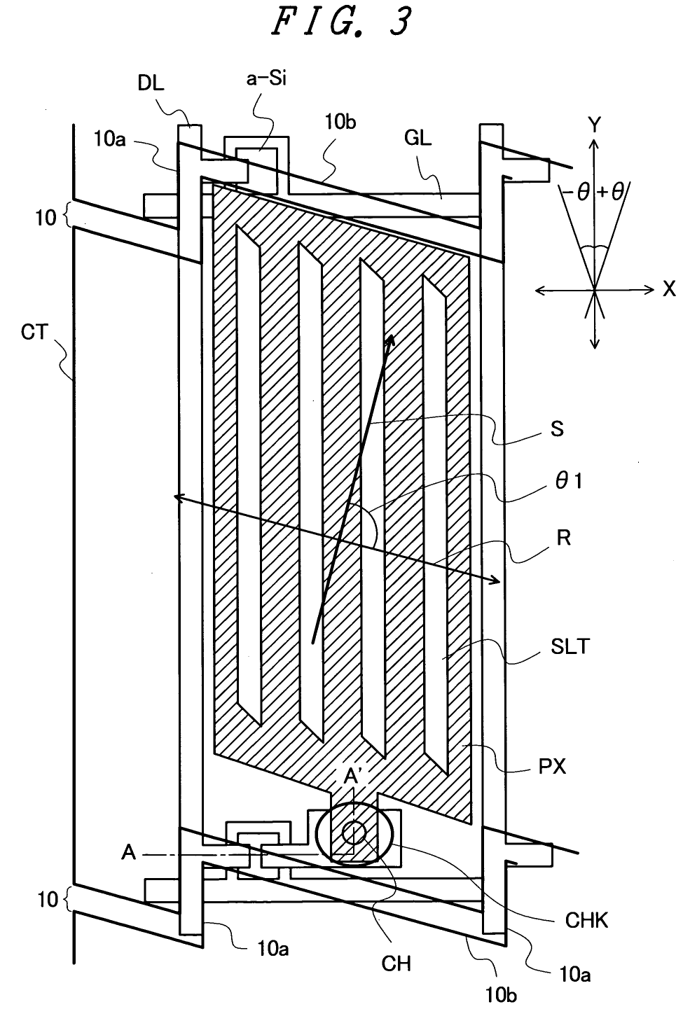

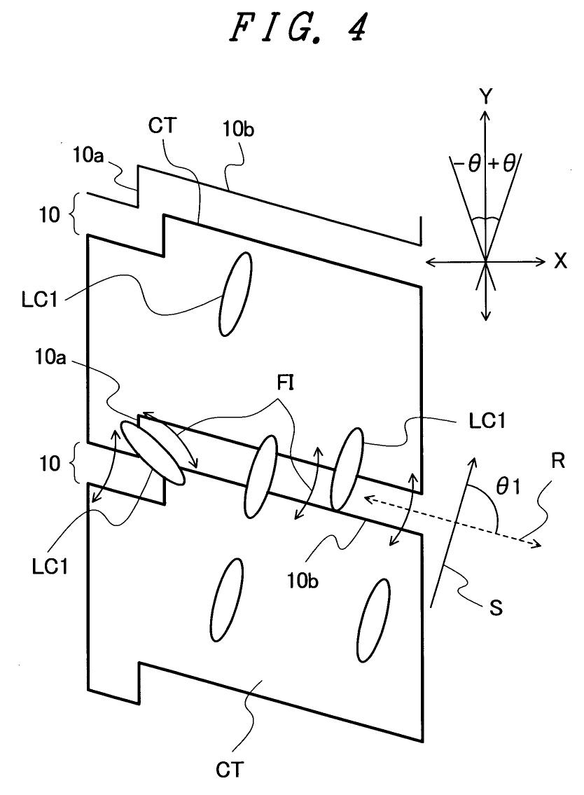

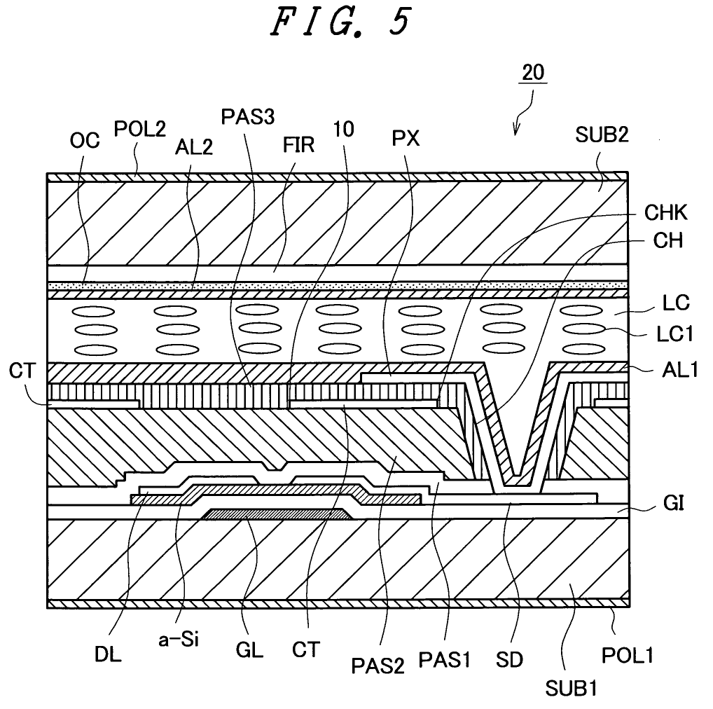

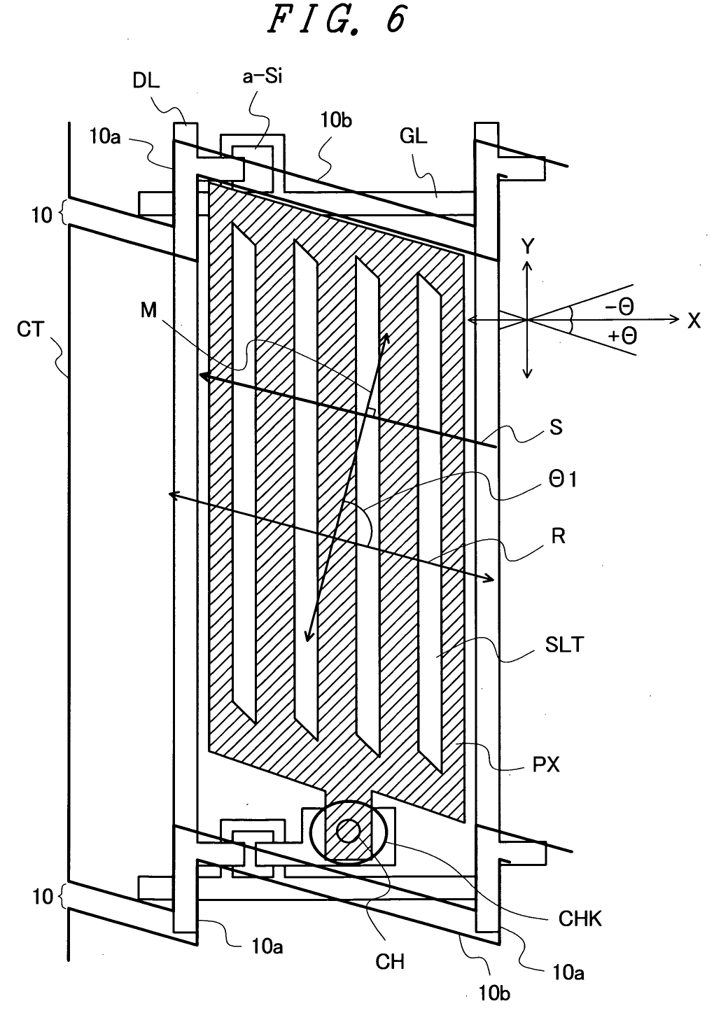

FIG. 1 to FIG. 6 are views relating to the IPS type liquid crystal display device as the first embodiment of the invention, in which FIG. 1 is a plan view showing a state where a counter electrode is divided for each display line, FIG. 2 is a plan view showing an electrode structure of each subpixel as viewed through the counter electrode of FIG. 1, FIG. 3 is a plan view enlarging a part of FIG. 2, showing a relation between a liquid crystal initial alignment axis and an extending direction of a gap between the counter electrodes when a positive liquid crystal is used, FIG. 4 is a schematic view for explaining a state where liquid crystal molecules move due to an electric field between two adjacent counter electrodes, FIG. 5 is across sectional view showing a cross sectional structure taken along the line A-A′ of FIG. 3, and FIG. 6 is a plan view enlarging a part of FIG. 2, showing a relation between a liquid crystal initial alignment axis and an extending direction of a gap between the counter electrodes when a negative liquid crystal is used.

The IPS type liquid crystal display device of the embodiment is fully transmissive and includes a liquid crystal display panel 20 shown in FIG. 5. The liquid crystal display panel 20 has a structure in which a liquid crystal layer (LC) including numerous liquid crystal molecules (LC1) is interposed between a first substrate (SUB1) and a second substrate (SUB2) with a main surface side of the second substrate (SUB2) being as an observation side as shown in FIG. 5. That is, the liquid crystal display panel 20 includes the first substrate (SUB1), the second substrate (SUB2) disposed opposing to the first substrate (SUB1), and the liquid crystal layer (LC) interposed between the first substrate (SUB1) and the second substrate (SUB2). For example, transparent insulating substrates such as glass are used as the first substrate (SUB1) and the second substrate (SUB2). For example, the positive liquid crystal or the negative liquid crystal is used as the liquid crystal layer (LC).

Further, the liquid crystal display panel 20 has a display section in which a plurality of subpixels 21 shown in FIG. 1 are disposed in a matrix form. Each of the plurality of subpixels 21 has a counter electrode (CT) and a pixel electrode (PX) (refer to FIG. 1 and FIG. 2).

Further, the liquid crystal display panel 20 has scanning lines (also referred to as gate lines) (GL) extending along the X direction and video lines (also referred to as drain lines) (DL) extending along the Y direction perpendicular (or crossing) to the X direction in a plan view as shown in FIG. 3. The scanning lines (GL) are provided in the Y direction at a predetermined interval, and the video lines (DL) are provided in the X direction at a predetermined interval. The scanning lines (GL) cross the video lines (DL) via an insulation film. A thin film transistor (TFT) used as a switching element of the subpixel 21 is provided in the vicinity of each crossing point where the scanning lines (GL) and the video lines (DL) cross each other.

Each of the plurality of subpixels 21 is disposed in a matrix form in the X direction and the Y direction. The plurality of subpixels 21 disposed in a line along the X direction constitute one display line, which is provided in plural in the Y direction.

As shown in FIG. 5, the scanning line (GL), a gate insulation film (GI), a semiconductor layer (a-Si), the video line (DL), a conductive layer (SD) functioning as a source electrode, an inter-layer insulation film (PAS1), an inter-layer insulation film (PAS2), the counter electrodes (CT; also referred to as common electrodes), an inter-layer insulation film (PAS3), the pixel electrode (PX), and a first alignment film (AL1) are successively formed from the first substrate (SUB1) side toward the liquid crystal layer (LC) on a liquid crystal surface side of the first substrate (SUB1).

A first polarizing film (POL1) is disposed outside (side opposite to the liquid crystal surface side) the first substrate (SUB1). Part (gate electrode) of the scanning line (GL), the gate insulation film (GI), the semiconductor layer (a-Si), part (drain electrode) of the video line (DL), and the conductive layer (SD; source electrode) constitute the thin film transistor (TFT).

As shown in FIG. 5, a color filter (FIR) of red, green, and blue, a planarizing film (OC), and a second alignment film (AL2) are successively formed from the second substrate (SUB2) toward the liquid crystal layer (LC) on a liquid crystal surface side of the second substrate (SUB2).

A second polarizing film (POL2) is disposed outside the second substrate (SUB2).

As shown in FIG. 5, the pixel electrode (PX) is formed in an upper layer than the counter electrode (CT) on the first substrate (SUB1) side. The pixel electrode (PX) and the counter electrode (CT) overlap with each other via the inter-layer insulation film (PAS3), thereby forming a holding capacitance. The pixel electrode (PX) and the counter electrode (CT) are formed of a transparent conductive layer such as Indium Tin Oxide (ITO).

As shown in FIG. 3, the pixel electrode (PX) has a structure in which a plurality of slits (SLT) extending along the Y direction are disposed in the X direction at a predetermined interval, and portions divided by the slits (SLT) are linear portions of the pixel electrode (PX). In the embodiment, although the slits (SLT) are closed at both ends, they may be opened at one end.

As shown in FIG. 1, the counter electrode (CT) is formed in a planar shape. Further, the counter electrode (CT) is divided for each display line. The counter electrode (CT) extends along the X direction in the same manner as the display line and is common for one display line. In two display lines adjacent to each other, a gap (break) 10 is provided between the counter electrode (CT) of one display line and the counter electrode (CT) of the other display line.

As shown in FIG. 3, the gap 10 has first portions 10a extending along an extending direction of the video lines (DL) and second portions 10b extending from the first portions 10a along a direction crossing the video lines (DL). The gap 10 extends in a direction of the display line as a whole while bending locally as shown in FIG. 1 and FIG. 2.

In FIG. 3 and FIG. 5, CH denotes a contact hole for electrically connecting the conductive layer (SD) functioning as a source electrode and the pixel electrode (PX) to each other, and CHK denotes an opening portion formed to the counter electrode (CT) for electrically separating the pixel electrode (PX) from the counter electrode (CT).

The video line (DL), the scanning line (GL), and the conductive layer (SD) are formed of a conductive film made of aluminum (Al), for example.

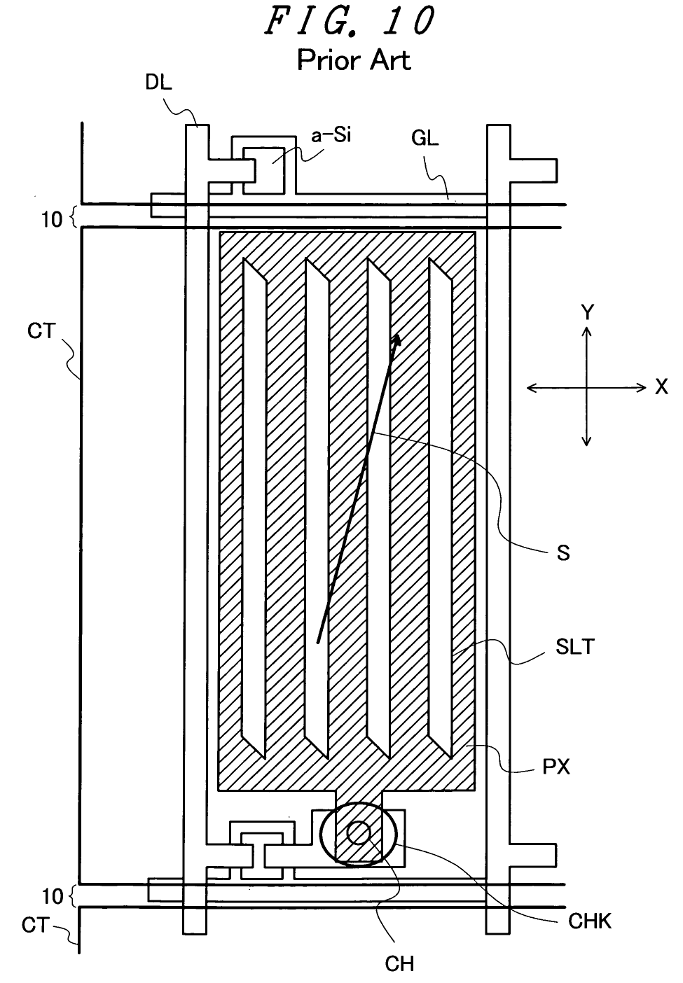

In the conventional IPS type liquid crystal display device, the counter electrode (CT) is divided for each display line and driven by one line inversion driving in order to reduce power consumption as shown in FIG. 10. When two adjacent display lines are defined as one display line and the other display line, respectively, the gap (break) 10 between the counter electrode (CT) of the one display line and the counter electrode (CT) of the other display line extends in a straight line fashion along a direction (extending direction of scanning line (GL)) of the display line. A liquid crystal initial alignment axis (S) of a liquid crystal layer is in a direction within a range of +70° to +80° or −70° to −80° clockwise with respect to the gap 10 (scanning line (GL)) in the case of the positive liquid crystal.

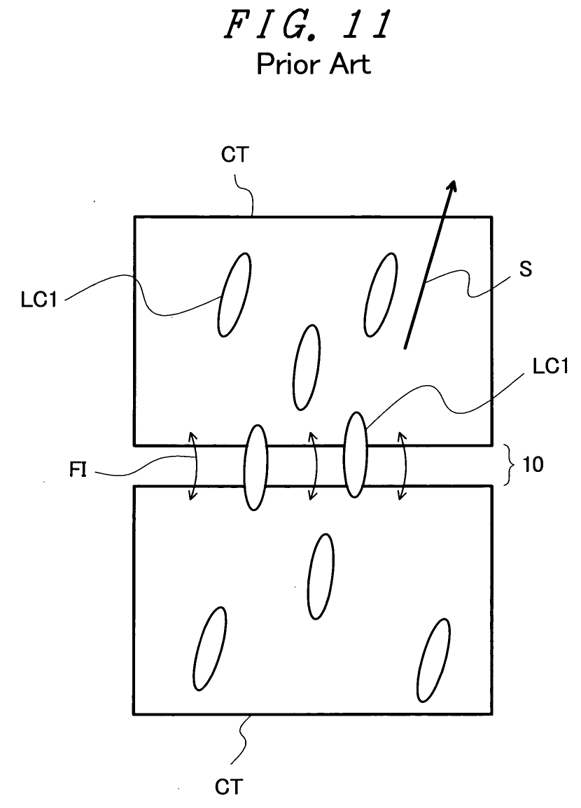

With the one line inversion driving, however, a reference voltage (counter voltage or common voltage) applied to the counter electrode (CT) of the one display line and a reference voltage (counter voltage or common voltage) applied to the counter electrode (CT) of the other display line are different in potential from each other (specifically, they are reversed in polarity from each other) in the two adjacent display lines. Therefore, an electric field (F1) is generated between the counter electrode (CT) of the one display line and the counter electrode (CT) of the other display line even at the time of black display as shown in FIG. 11. Thus, liquid crystal molecules (LC1) in the liquid crystal layer move in a direction different from the liquid crystal initial alignment axis (S) to form a light leakage point (black floating point). As a result, the display quality could conceivably be degraded. The term “reverse in polarity” as used herein means that the potential of the counter electrode (CT) is switched between higher and lower potentials than the pixel electrode (PX) regardless of whether the potential is higher or lower than 0V.

In view of this, the liquid crystal initial alignment axis (S) of the liquid crystal layer (LC) and the extending direction of the gap 10 are devised so that the liquid crystal molecules (LC1) in the liquid crystal layer (LC) are not driven even when the electric field (FI) is generated between the counter electrode (CT) of the one display line and the counter electrode (CT) of the other display line. Specifically, the technique varies depending on the kind of liquid crystal.

In the case where the liquid crystal layer (LC) is of the positive liquid crystal, the gap 10 between the respective counter electrodes (CT) of the two adjacent display lines is formed so as to extend in a direction of the display line as a whole while bending locally with the first portions 10a extending along the extending direction of the video lines (DL) and the second portions 10b extending from the first portions 10a along a direction crossing the video lines (DL) as shown in FIG. 3. The liquid crystal initial alignment axis (S) of the liquid crystal layer (LC) is made in a direction within a range of +5° to +20° or −5° to −20° (±θ) clockwise with respect to the video line (DL) (Y direction). When an angle measured clockwise from the liquid crystal initial alignment axis (S) of the liquid crystal layer (LC) to the second portion 10b (R) of the gap 10 is θ1, a relation of 88°≦θ1≦92° is satisfied. This means that the direction of the electric field (FI) generated at the second portion 10b of the gap 10 substantially coincides with the liquid crystal initial alignment axis (S) of the liquid crystal layer (LC) as shown in FIG. 4. In the second portion 10b, the movement (rotation from the liquid crystal initial alignment axis (S)) of the liquid crystal molecules (LC1) in the liquid crystal layer (LC) in a direction different from the liquid crystal initial alignment axis (S) due to the electric field (FI) generated between the two adjacent counter electrodes (CT) can be suppressed. In the first portion 10a of the gap 10, however, the liquid crystal molecules (LC1) in the liquid crystal layer (LC) move in a direction different from the liquid crystal initial alignment axis (S) due to the electric field (FI) generated between the two adjacent counter electrodes (CT). Consequently, the first portion 10a of the gap 10 is disposed so as to planary overlap with the video line (DL). And, the video line (DL) is formed of a light-shielding material to block light.

This configuration can suppress the light leakage at the time of black display while minimizing (maximally improving an aperture ratio) an area of a portion where the liquid crystal molecules (LC1) in the liquid crystal layer (LC) move in a direction different from the liquid crystal initial alignment axis (S) due to the electric field (FI) generated between the two adjacent counter electrodes (CT). Accordingly, it is possible to improve the display quality while maximally improving an aperture ratio in the IPS type liquid crystal display device.

In the case where the liquid crystal layer (LC) is of the negative liquid crystal, since the liquid crystal molecules (LC1) tend to align in a direction perpendicular to the electric field (FI) unlike the positive liquid crystal, the liquid crystal initial alignment axis (S) is changed by 90° compared with the case of the positive liquid crystal. That is, the gap 10 between the respective counter electrodes (CT) of the two adjacent display lines is formed so as to extend in a direction of the display line as a whole while bending locally with the first portions 10a extending along the extending direction of the video lines (DL) and the second portions 10b extending from the first portions 10a along a direction crossing the video lines (DL) as shown in FIG. 6. The liquid crystal initial alignment axis (S) of the liquid crystal layer (LC) is made in a direction within a range of +5° to +20° or −5° to −20° (±Θ) clockwise with respect to the scanning line (GL). When an angle measured clockwise from a direction (M) perpendicular to the liquid crystal initial alignment axis (S) of the liquid crystal layer (LC) to the second portion 10b (R) of the gap 10 is Θ1, a relation of 88°≦Θ1≦92° is satisfied.

Also in this case, in the second portion 10b, the movement (rotation from the liquid crystal initial alignment axis (S)) of the liquid crystal molecules (LC1) in the liquid crystal layer (LC) in a direction different from the liquid crystal initial alignment axis (S) due to the electric field (FI) generated between the two adjacent counter electrodes (CT) can be suppressed. In the first portion 10a of the gap 10, however, the liquid crystal molecules (LC1) in the liquid crystal layer (LC) move in a direction different from the liquid crystal initial alignment axis (S) due to the electric field (FI) generated between the two adjacent counter electrodes (CT). Consequently, the first portion 10a of the gap 10 is disposed so as to planary overlap with the video line (DL). And, the video line (DL) is formed of a light-shielding material to block light.

This configuration can suppress the light leakage at the time of black display while minimizing (maximally improving an aperture ratio) an area of a portion where the liquid crystal molecules (LC1) in the liquid crystal layer (LC) move in a direction different from the liquid crystal initial alignment axis (S) due to the electric field (FI) generated between the two adjacent counter electrodes (CT) also in the case of the negative liquid crystal. Accordingly, it is possible to improve the display quality while maximally improving an aperture ratio in the IPS type liquid crystal display device.

The above-described Patent Documents 1 and 2 do not describe that the gap 10 between the respective counter electrodes (CT) of the two adjacent display lines is formed so as to extend in a direction of the display line as a whole while bending locally with the first portions 10a extending along the extending direction of the video lines (DL) and the second portions 10b extending from the first portions 10a along a direction crossing the video lines (DL), and that the display quality is improved while maximally improving an aperture ratio, as in the embodiment.

### Second Embodiment

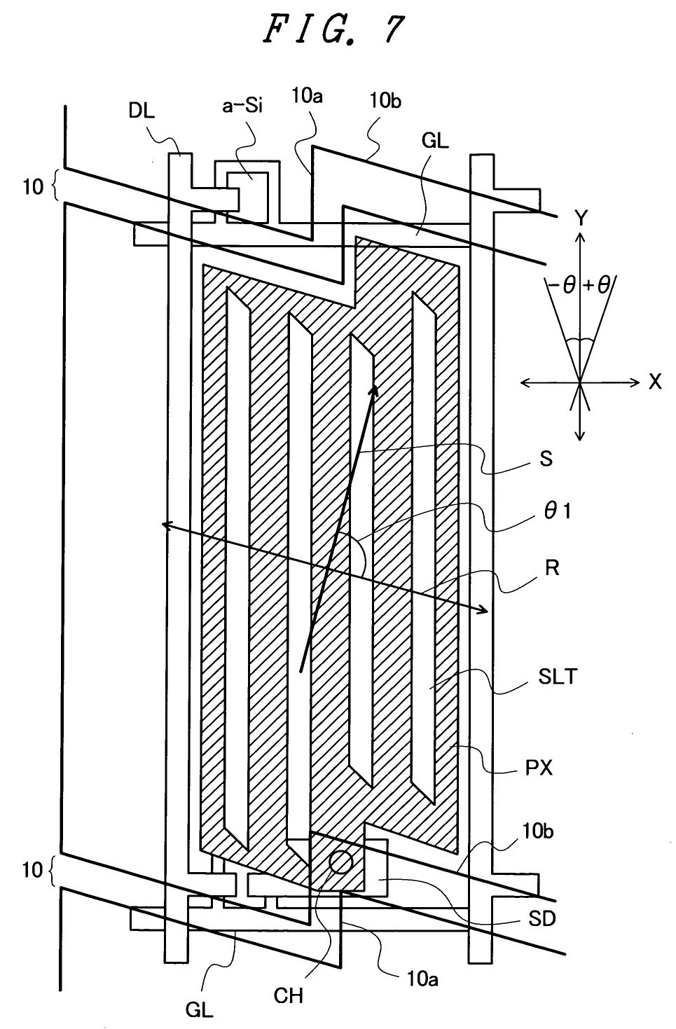

FIG. 7 is a plan view showing an electrode structure of one subpixel in an IPS type liquid crystal display device as a second embodiment of the invention.

The IPS type liquid crystal display device of the second embodiment basically has a similar configuration to that of the first embodiment but is different in the following configuration.

That is, in the first embodiment, as a countermeasure for the light leakage point caused by the movement of the liquid crystal molecules (LC1) in a direction different from the liquid crystal initial alignment axis (S) in the first portion 10a of the gap 10 due to the electric field (FI) generated between the two adjacent counter electrodes (CT), the first portion 10a of the gap 10 is disposed so as to planary overlap with the video line (DL).

In the second embodiment, on the other hand, the first portion 10a of the gap 10 is formed in a lower layer than the counter electrode (CT) and disposed so as to planary overlap with the conductive layer (SD) electrically connected with the pixel electrode (PX) as shown in FIG. 7. And, the conductive layer (SD) is formed of a light-shielding material to block light.

In the second embodiment with this configuration, the display quality can be improved while maximally improving an aperture ratio in the IPS type liquid crystal display device as in the first embodiment.

A part of the first portion 10a of the gap 10 sometimes protrudes from the conductive layer (SD), in which case, it is sufficient that light is blocked by the scanning line (GL) or a separately provided light-shielding film. Even in such a case, an area for providing a light-shielding film can be decreased compared with the case where the invention is not applied, which can provide an advantage of maximally improving an aperture ratio.

Further, in the case of the example shown in FIG. 7, since the contact hole (CH) is overlapped with the gap 10, the opening portion (CHK) provided to the counter electrode (CT) can be omitted.

Although FIG. 7 shows the case of using the positive liquid crystal, a similar advantage can be provided also in the case of using the negative liquid crystal in the second embodiment. In this case, it is sufficient that a position of the first portion 10a of the gap 10 is changed to a position like in FIG. 7 while the basic configuration remains the same as in FIG. 6.

### Third Embodiment

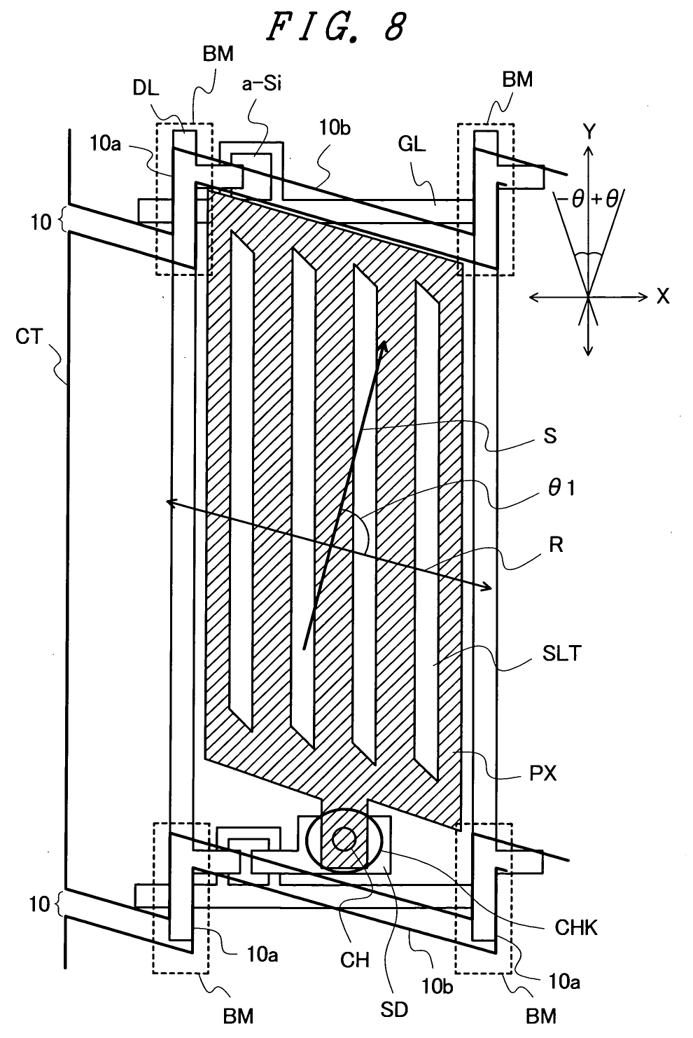

FIG. 8 is a plan view showing an electrode structure of one subpixel in an IPS type liquid crystal display device as a third embodiment of the invention.

The IPS type liquid crystal display device of the third embodiment basically has a similar configuration to that of the first embodiment but is different in the following configuration.

That is, as a countermeasure for the light leakage point caused by the movement of the liquid crystal molecules (LC1) in a direction different from the liquid crystal initial alignment axis (S) in the first portion 10a of the gap 10 due to the electric field (FI) generated between the two adjacent counter electrodes (CT), the first portion 10a of the gap 10 is disposed so as to planary overlap with a light-shielding film (BM; black matrix) in the third embodiment as shown in FIG. 8. The light-shielding film (BM) is provided on the liquid crystal layer side of the second substrate (SUB2).

Also in the third embodiment with this configuration, the display quality can be improved while maximally improving an aperture ratio in the IPS type liquid crystal display device as in the first embodiment.

In FIG. 8, although the first portion 10a of the gap 10 is disposed so as to overlap with the video line (DL) and the light-shielding film (BM), the first portion 10a of the gap 10 may be disposed so as to planary overlap with the light-shielding film (BM) in portions other than the video line (DL). In short, the countermeasure for the light leakage point in the first portion 10a of the gap 10 is implemented by planary overlapping the first portion 10a of the gap 10 with the light-shielding film (BM).

Although FIG. 8 shows the case of using the positive liquid crystal, a similar advantage can be provided also in the case of using the negative liquid crystal in the third embodiment.

### Fourth Embodiment

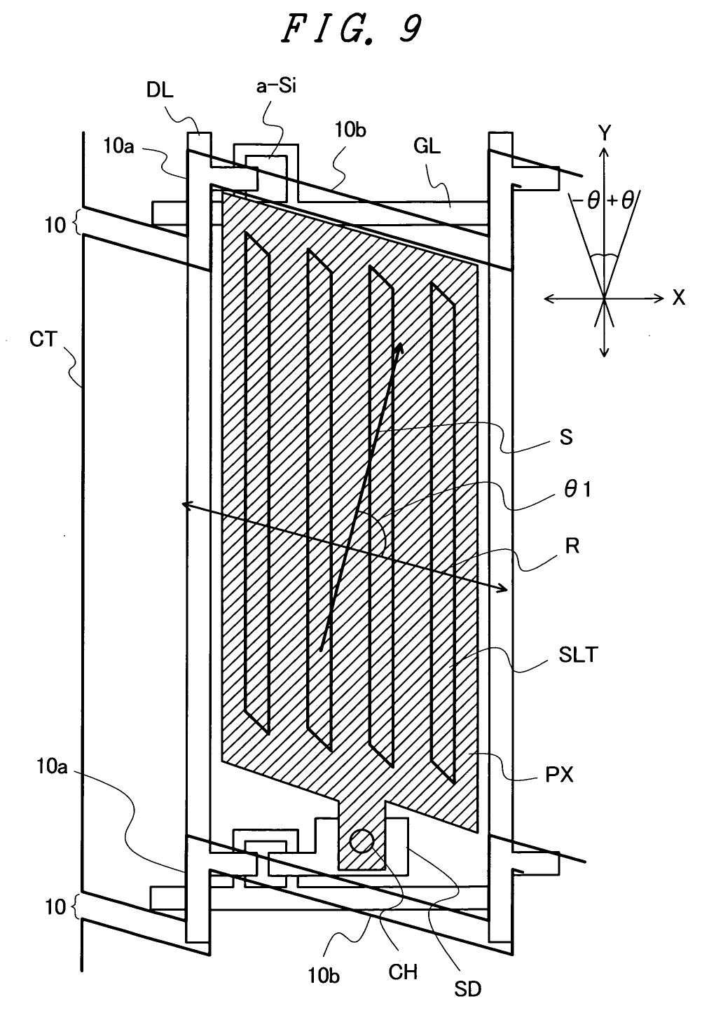

FIG. 9 is a plan view showing an electrode structure of one subpixel in an IPS type liquid crystal display device as a fourth embodiment of the invention.

The IPS type liquid crystal display device of the fourth embodiment basically has a similar configuration to that of the first embodiment but is different in the following configuration.

That is, in the first embodiment, the pixel electrode (PX) is disposed in an upper layer than the counter electrode (CT) on the first substrate (SUB1) side.

In the fourth embodiment, on the other hand, the counter electrode (CT) is disposed in an upper layer than the pixel electrode (PX) on the first substrate (SUB1) side as shown in FIG. 9. The slits (SLT) are provided to the counter electrode (CT) not to the pixel electrode (PX). Further, since the pixel electrode (PX) is provided in a lower layer than the counter electrode (CT) via the insulation film, the opening portion (CHK) provided to the counter electrode (CT) is unnecessary.

Also in the fourth embodiment with this configuration, the display quality can be improved while maximally improving an aperture ratio in the IPS type liquid crystal display device as in the first embodiment.

Although FIG. 9 shows the case of using the positive liquid crystal, a similar advantage can be provided also in the case of using the negative liquid crystal in the fourth embodiment.

Further, the fourth embodiment may be combined with the second and third embodiments.

The invention made by the inventor has been specifically described based on the embodiments. However, the invention is not limited to the embodiments, and it is apparent that the invention can be variously changed within a scope not departing from the gist thereof.

What is claimed is:

1. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels,
the liquid crystal layer is of a positive liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the video line,
when an angle measured clockwise from the initial alignment axis of the liquid crystal layer to the second portion of the gap is θ1, a relation of 88°≦θ1≦92° is satisfied,
the video line is formed of a light-shielding material, and
the first portion of the gap is planary overlapped with the video line.

2. A liquid crystal display device according to claim 1, wherein the pixel electrode is formed in an upper layer than the counter electrode on the first substrate side.

3. A liquid crystal display device according to claim 1, wherein the counter electrode is formed in an upper layer than the pixel electrode on the first substrate side.

4. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels,
the liquid crystal layer is of a positive liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the video line,
when an angle measured clockwise from the initial alignment axis of the liquid crystal layer to the second portion of the gap is θ1, a relation of 88°≦θ1≦92° is satisfied, and
the first portion of the gap is planary overlapped with a light-shielding metal electrode, the light-shielding metal electrode is formed in a lower layer than the counter electrode and electrically connected with the pixel electrode.

5. A liquid crystal display device according to claim 4, wherein the pixel electrode is formed in an upper layer than the counter electrode on the first substrate side.

6. A liquid crystal display device according to claim 4, wherein the counter electrode is formed in an upper layer than the pixel electrode on the first substrate side.

7. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels,
the liquid crystal layer is of a positive liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the video line,
when an angle measured clockwise from the initial alignment axis of the liquid crystal layer to the second portion of the gap is θ1, a relation of 88°≦θ1≦92° is satisfied,
the second substrate has a light-shielding film in an area opposing to the first portion of the gap, and
the first portion of the gap is planary overlapped with the light-shielding film.

8. A liquid crystal display device according to claim 7, wherein the pixel electrode is formed in an upper layer than the counter electrode on the first substrate side.

9. A liquid crystal display device according to claim 7, wherein the counter electrode is formed in an upper layer than the pixel electrode on the first substrate side.

10. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels and a plurality of scanning lines extending along a direction crossing the video lines,
the liquid crystal layer is of a negative liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the scanning line,
when an angle measured clockwise from a direction perpendicular to the initial alignment axis of the liquid crystal layer to the second portion of the gap is Θ1, a relation of 88°≦Θ1≦92° is satisfied,
the video line is formed of a light-shielding material, and
the first portion of the gap is planary overlapped with the video line.

11. A liquid crystal display device according to claim 10, wherein the pixel electrode is formed in an upper layer than the counter electrode on the first substrate side.

12. A liquid crystal display device according to claim 10, wherein the counter electrode is formed in an upper layer than the pixel electrode on the first substrate side.

13. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels and a plurality of scanning lines extending along a direction crossing the video lines,
the liquid crystal layer is of a negative liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the scanning line,
when an angle measured clockwise from a direction perpendicular to the initial alignment axis of the liquid crystal layer to the second portion of the gap is Θ1, a relation of 88°≦Θ1≦92° is satisfied, and
the first portion of the gap is planary overlapped with a light-shielding metal electrode, the light-shielding metal electrode is formed in a lower layer than the counter electrode and electrically connected with the pixel electrode.

14. A liquid crystal display device according to claim 13, wherein the pixel electrode is formed in an upper layer than the counter electrode on the first substrate side.

15. A liquid crystal display device according to claim 13, wherein the counter electrode is formed in an upper layer than the pixel electrode on the first substrate side.

16. A liquid crystal display device comprising a liquid crystal display panel having a first substrate, a second substrate, and a liquid crystal layer interposed between the first substrate and the second substrate,
the liquid crystal display panel having a plurality of subpixels,
each of the plurality of subpixels having a counter electrode formed above the first substrate, a pixel electrode formed above the first substrate, and an insulation film formed between the counter electrode and the pixel electrode, the pixel electrode overlapping with the counter electrode via the insulation film, and
the counter electrode and the pixel electrode causing an electric field to be generated due to a potential difference therebetween thereby driving liquid crystal in the liquid crystal layer, wherein
the first substrate has a plurality of video lines for inputting a video signal to each of the subpixels and a plurality of scanning lines extending along a direction crossing the video lines,
the liquid crystal layer is of a negative liquid crystal,
the counter electrode is divided for each display line,
when two adjacent display lines are defined as one display line and the other display line, respectively, a gap between the counter electrode of said one display line and the counter electrode of said the other display line extends in a direction of the display line as a whole while bending locally,
the gap has a first portion extending along an extending direction of the video line and a second portion extending from the first portion along a direction crossing the video line,
an initial alignment axis of the liquid crystal layer is in a direction within a range of +5° to +20° or −5° to −20° clockwise with respect to the scanning line,
when an angle measured clockwise from a direction perpendicular to the initial alignment axis of the liquid crystal layer to the second portion of the gap is Θ1, a relation of 88°≦Θ1≦92° is satisfied, and
the second substrate has a light-shielding film in an area opposing to the first portion of the gap, and
the first portion of the gap is planary overlapped with the light-shielding film.

17. A liquid crystal display device according to claim 16, wherein the pixel electrode is formed in an upper layer than the counter electrode on the first substrate side.

18. A liquid crystal display device according to claim 16, wherein the counter electrode is formed in an upper layer than the pixel electrode on the first substrate side.
